(19) United States
(12) Patent Application Publication
(10) Pub. No.: US 2026/0214729 A1
(43) Pub. Date: Jul. 23, 2026

(54) COMMUNICATION APPARATUS AND COMMUNICATION METHOD FOR ENHANCED TUNNELLED DIRECT LINK SETUP

(71) Applicant: Panasonic Intellectual Property Corporation of America, Torrance, CA (US)

(72) Inventors: Rajat PUSHKARNA, Singapore (SG); Yoshio URABE, Nara (JP)

(73) Assignee: Panasonic Intellectual Property Corporation of America, Torrance, CA (US)

(21) Appl. No.: 19/140,241

(22) PCT Filed: Nov. 30, 2023
(86) PCT No.: PCT/SG2023/050797

§ 371 Date: Jun. 17, 2025

(30) Foreign Application Priority Data
Dec. 22, 2022 (SG) 10202260557P

(51) Int. Cl. H04W 76/14; H04W 76/12

(52) U.S. Cl. CPC H04W 76/14; H04W 76/12

(57) ABSTRACT

Communication devices and methods for enhanced tunnelled direct link setup (TDLS) are provided. One exemplary embodiment provides a first wireless communication apparatus associated to a first access point (AP), the first wireless communication apparatus comprising: a transmitter, which in operation, transmits a request frame to a second wireless communication apparatus which is associated to a second AP for peer-to-peer communication; and a receiver, which in operation, receives a response frame from the second wireless communication apparatus in response to the request frame.

### TECHNICAL FIELD

The present disclosure generally relates to communication methods and apparatuses, and more particularly relates to methods and apparatuses for enhanced tunnelled direct link setup (TDLS).

### BACKGROUND

Tunnelled direct link setup (TDLS) allows direct peer to peer communication between two non-access point (non-AP) stations (STAs) in an 802.11 BSS. All management frames involved in the setup of TDLS (except TDLS Discovery Response) are encapsulated within Data frames, so the setup of TDLS is completely transparent to an AP associated with the non-AP STAs. In fact, the AP does not even need to be TDLS capable.

However, there is still limited discussion on communication apparatuses and methods for enhanced TDLS.

There is thus a need for communication apparatuses and methods that can solve the above-mentioned issues. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for enhanced TDLS.

According to an aspect of the present disclosure, there is provided a first wireless communication apparatus associated to a first access point (AP), the first wireless communication apparatus comprising: a transmitter, which in operation, transmits a request frame to a second wireless communication apparatus which is associated to a second AP for peer-to-peer communication; and a receiver, which in operation, receives a response frame from the second wireless communication apparatus in response to the request frame.

According to another aspect of the present disclosure, there is provided a second wireless communication apparatus associated to a second AP, the second wireless communication apparatus comprising: a receiver, which in operation, receives a request frame from a first wireless communication apparatus via a first AP associated with the first wireless communication apparatus and the second AP, the request frame indicating a request for peer-to-peer communication with the second wireless communication apparatus; and a transmitter, which in operation, transmits a response frame to the first wireless communication apparatus in response to the request frame.

According to another aspect of the present disclosure, there is provided a communication method comprising: transmitting, from a first wireless communication apparatus, a request frame to a second wireless communication apparatus via a first AP associated with the first wireless communication apparatus and a second AP associated with the second wireless communication apparatus, the request frame indicating a request for peer-to-peer communication with the second wireless communication apparatus; and receiving a response frame from the second wireless communication apparatus in response to the request frame.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts an example illustration of a tunnelled direct link setup (TDLS) scenario.

FIG. 2A depicts an example illustration of a TDLS discovery process using TDLS Discovery frames.

FIG. 2B depicts an example illustration of TDLS discovery process using Access Network Query Protocol (ANQP) frames.

FIG. 3 depicts an example illustration of an Extended Service Set (ESS) network.

FIG. 4 depicts an example illustration of a Basic Service Set (BSS) network.

FIG. 5 depicts an example illustration of an Overlapping Basic Service Set (OBSS) network.

FIG. 6 depicts an illustration of an enhanced TDLS setup procedure according to various embodiment of the present disclosure.

FIG. 7A depicts an illustration of a TDLS Discovery Request frame format according to an embodiment of the present disclosure.

FIG. 7B depicts an illustration of a TDLS Discovery Response frame format according to an embodiment of the present disclosure.

FIG. 8 depicts an illustration of a TDLS Discovery frame exchange signalling flow diagram for an AP-to-AP wired backhaul according to an embodiment of the present disclosure.

FIG. 9 depicts an illustration of a TDLS Discovery frame exchange signalling flow diagram for an AP-to-AP wireless backhaul according to an embodiment of the present disclosure.

FIG. 10 depicts an illustration of a 4-address Data frame format for AP-to-AP communication according to an embodiment of the present disclosure.

FIG. 11 depicts an illustration of an enhanced TDLS Discovery procedure in which a Link Identifier element in the TDLS Discovery frames indicate a BSS Identifier (BSSID) of a BSS associated with a TDLS initiator according to an embodiment of the present disclosure.

FIG. 12 depicts an illustration of an enhanced TDLS Discovery procedure in which a Link Identifier element in the TDLS Discovery frames indicate a BSSID of a BSS associated with a TDLS peer STA according to an embodiment of the present disclosure.

FIG. 13 depicts an illustration of an enhanced TDLS Discovery procedure in which a Link Identifier element in the TDLS Discovery frames indicate BSSIDs of a BSS associated with a TDLS initiator and a BSS associated with a TDLS peer STA according to an embodiment of the present disclosure.

FIG. 14A depicts a Link Identifier element for use in the illustration of FIG. 11 according to an embodiment of the present disclosure.

FIG. 14B depicts a Link Identifier element for use in the illustration of FIG. 12 according to an embodiment of the present disclosure.

FIG. 14C depicts a Link Identifier element for use in the illustration of FIG. 13 according to an embodiment of the present disclosure.

FIG. 15 depicts an illustration of overall signalling details of an enhanced TDLS Discovery procedure according to an embodiment of the present disclosure.

FIG. 16 depicts a security negotiation procedure for a TDLS link according to an embodiment of the present disclosure.

FIG. 17 depicts an illustration of a Fast BSS Transition (FTE) element for deriving a TDLS PeerKey (TDK) in a TDLS link security negotiation procedure according to an embodiment of the present disclosure.

FIG. 18 depicts a variation of a TDLS Discovery Response frame format according to an embodiment of the present disclosure.

FIG. 19 depicts an illustration of a TDLS implementation with multiple BSSIDs according to an embodiment of the present disclosure.

FIG. 20 depicts a block diagram of a STA suitable for communication in accordance with various embodiments of the present disclosure.

FIG. 21 shows a flow diagram illustrating a method for enhanced TDLS according to various embodiments of the present disclosure.

FIG. 22 shows a schematic, partially sectioned view of a STA that can be implemented for enhanced TDLS in accordance with various embodiments of the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. There is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for enhanced TDLS.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a station may be a laptop, a desktop personal computer (PC), a personal digital assistant (PDA), either an access point or not (e.g., either an AP STA or a non-AP STA), or a Wi-Fi phone in a wireless local area network (WLAN) environment. The station may be fixed or mobile. In the WLAN environment, the terms “STA”, “non-AP STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at different occasions, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

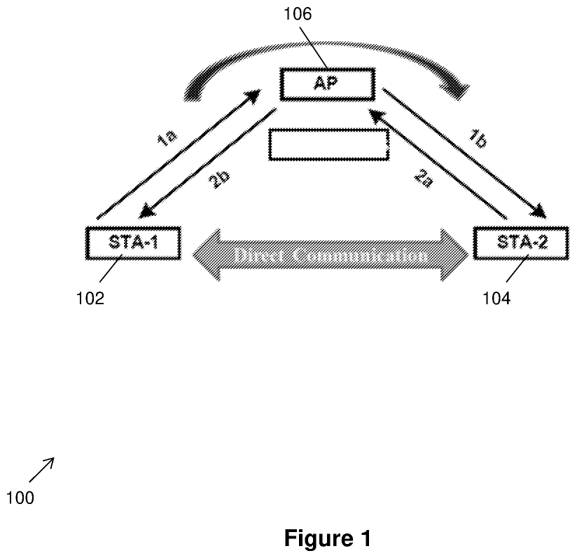

FIG. 1 depicts an example illustration 100 of a tunnelled direct link setup (TDLS) between STA 102 and STA 104 which are associated with an AP 106. In this example, STA 102 initiates the TDLS setup and is thus referred to as the TDLS initiator, while STA 104 is referred to as the TDLS responder or peer STA. The setup generally involves the STA 102 sending a TDLS discovery or setup request to STA 104 via the AP 106, and then STA 104 responds by sending a TDLS discovery or setup response to STA 102 via the AP 106. STA 102 and STA 104 can then communicate directly with each other without going through AP 106 after the TDLS setup is successfully completed.

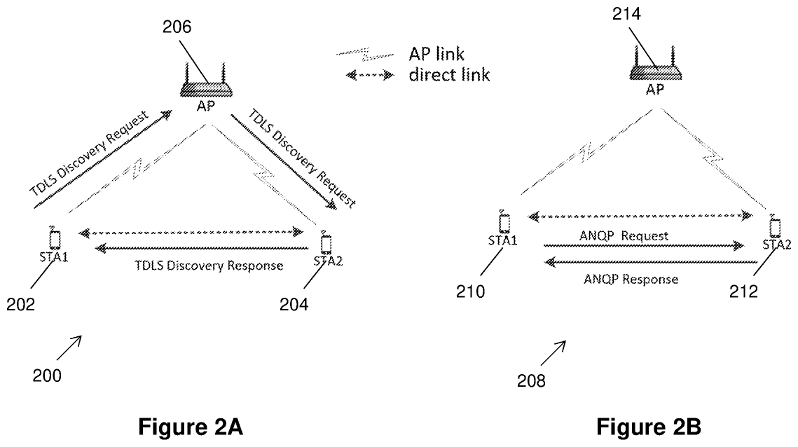

TDLS Discovery may be performed using TDLS Discovery frames, for example as shown in illustration 200 of FIG. 2A. TDLS initiator STA 202 transmits a TDLS Discovery Request frame via AP 206 to STA 204. If the STA 204 supports TDLS, it transmits a TDLS Discovery Response frame directly (e.g., via a direct link or path without going through the AP 206) to the STA 202. TDLS Discovery may also be performed by exchanging Access Network Query Protocol (ANQP) Request/Response frames (e.g., Group Address GAS Request/Response frames) over a direct path, as shown in illustration 208 of FIG. 2B. For example, STA 210 transmits an ANQP Request frame to STA 212 directly (e.g., via a direct link or path without going through the AP 214). If the STA 212 supports TDLS, it transmits an ANQP Response directly to the STA 210.

In home and enterprise scenarios, it is possible that there are multiple APs in the vicinity and a number of STAs are available forming an Overlapping Basic Service Set (OBSS). In a OBSS scenario, it is possible that there are multiple clients which are very close to each other. Future amendments to mainstream WiFi can make use of this to enable peer-to-peer with clients in an OBSS.

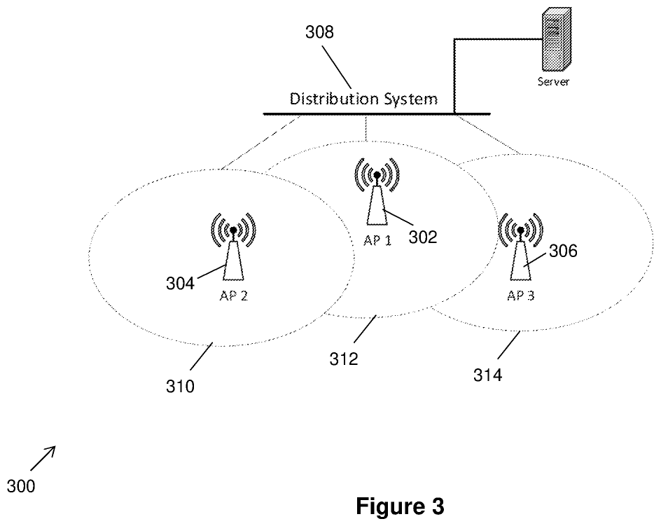

Further, in current home or enterprise scenarios, it is possible that a network comprises of multiple APs forming an ESS (Extended Service Set). An ESS refers to a set of one or more basic service sets (BSSs) that are interconnected by a single distribution system (DS). An ESS appears as a single IEEE 802 access domain to the logical link control (LLC) sublayer. FIG. 3 depicts an example illustration 300 of an ESS network, in which APs 302, 304 and 306 (each having a BSS 310, 312 and 314 respectively) are interconnected by a DS 308. To improve throughput, 802.11 also has provision of co-located APs, e.g., a same physical device may have 2 APs operating on different channels.

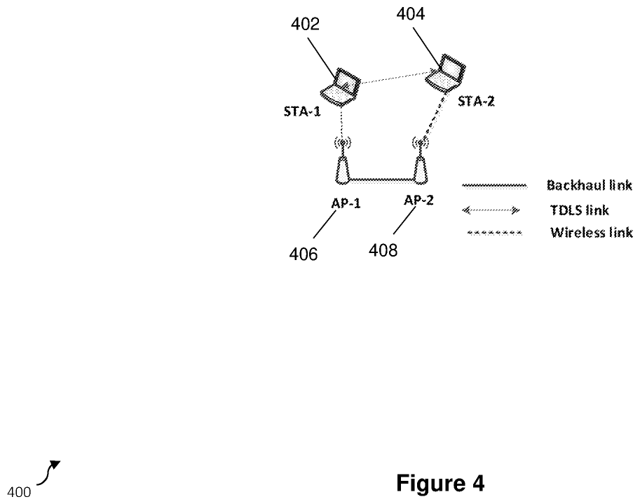

In the current IEEE specifications, the Tunnelled Direct Link Setup (TDLS) is a procedure in that “TDLS is characterized by encapsulating setup frames in Data frames, which allows them to be transmitted through an AP”. For example, referring to illustration 400 of FIG. 4, STA 402 is wirelessly linked to AP 406 and STA 404 is wirelessly linked to AP 408. APs 406 and 408 are connected via a backhaul link such that they are part of an ESS. TDLS setup can be performed so that STA 402 and 404 can communicate directly with each other via a direct link without going through AP 406 and AP 408.

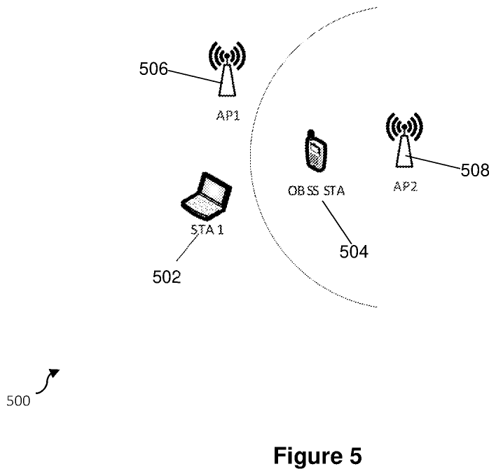

In the current 802.11 specification, TDLS mechanism is only for peer-to-peer communication within a same BSS. The present disclosure proposes solutions for enabling TDLS mechanism to establish a peer-to-peer (P2P) link with a client in a OBSS scenario, such as shown in illustration 500 of FIG. 5, in where STA 502 (associated with an AP 506 in a BSS) can perform direct communication with STA 504 (associated with an AP 508 in an OBSS).

A solution for enabling a TDLS Initiator to establish TDLS setup with a TDLS responder in an OBSS is as follows. The TDLS initiator performs discovery of a client in the OBSS by forwarding a TDLS Discovery frame from its AP to the OBSS AP. The TDLS Discovery response is received by the TDLS initiator on a direct link if the OBSS STA (e.g., the TDLS responder) is within the radio range of the TDLS initiator. The TDLS initiator performs TDLS link setup by forwarding a TDLS Setup request from its AP to the OBSS AP. For security purposes, a TDLS PeerKey (TPK) security key may be generated for both the peer STAs incorporating a Link Identifier element taking into consideration the OBSS AP.

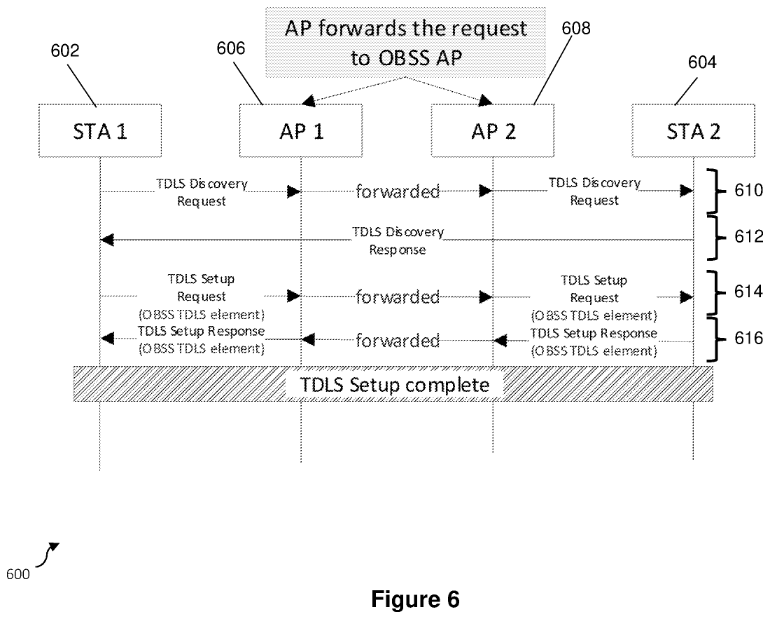

FIG. 6 depicts an illustration 600 of an enhanced TDLS setup procedure according to various embodiment of the present disclosure. TDLS Initiator STA 602 encapsulates a TDLS Discovery Request frame 610 to make it transparent to the AP and transmits it to peer STA 604 in an OBSS via AP 606 (e.g., associated with STA 602) and AP 608 (e.g., associated with STA 608). For example, the TDLS Discovery Request frame 610 is forwarded from the AP 606 to the AP 608. A TDLS Discovery Response frame 612 (from STA 604 to STA 602) is received on a direct link between STA 604 to STA 602. This verifies that the STAs are in radio range of each other and a TDLS Setup can be initiated. OBSS STA 604 is thus identified during the discovery phase. Upon receiving the TDLS Discovery Response frame 612, the TDLS Initiator STA 602 may setup a TDLS link with the peer STA 604. TDLS related parameters are then exchanged during a TDLS Setup Request frame 614 and Response frame 616 exchange. During the TDLS Setup, security related negotiation may take place for the direct link to establish a secure direct link for data communication. A TPK key may be generated based on information contained in a Link Identifier element which may have BSS Identifiers (BSSIDs) of both the BSSs (e.g., the BSS associated with the STA 602 and AP 606, as well as the BSS associated with the STA 604 and AP 608) or at least one of the BSSIDs.

Enhanced TDLS (eTDLS) is characterized by encapsulating setup frames in data frames, which allows them to be transmitted through one or more APs transparently. Therefore, each AP does not need to be direct link capable, nor does it have to support the same capabilities that are used on the TDLS link between the two TDLS peer STAs. eTDLS also includes power saving, in the form of TDLS peer PSM (scheduled) and TPU (unscheduled). STAs that set up eTDLS direct link would remain associated with their BSS, but have the options of transmitting frames directly on the direct link. Class 3 data frames may be used for data frames transmitted between STAs in an infrastructure BSS or in an MBSS, and for data frames between TDLS peer STAs in different BSSs. Management frames used for eTDLS would follow the same rules as traditional TDLS.

During eTDLS discovery, a TDLS Initiator may transmit a TDLS Discovery Request frame to a peer STA in an OBSS by encapsulating the TDLS Discovery Request frame in a payload of an Ethertype 89-0d Data frame. The TDLS Discovery Request frame is transmitted to the peer STA via more than one AP as the peer STA is present in the OBSS. The TDLS Discovery Request frame is relayed between an AP in the BSS of the TDLS initiator to the AP of the peer STA (frame relay between APs is not within the scope of 802.11). The peer STA receiving the TDLS Discovery Request frame shall respond with the TDLS Discovery Response frame over a direct link to the TDLS Initiator. The BSSID of the peer STA and/or the BSSID of the TDLS Initiator may be present in the exchanged TDLS Discovery and Setup frames to identify that TDLS Setup belongs to peer STAs between those BSSIDs. Further, it is assumed that the peer STA is operating on the same channel as the TDLS initiator.

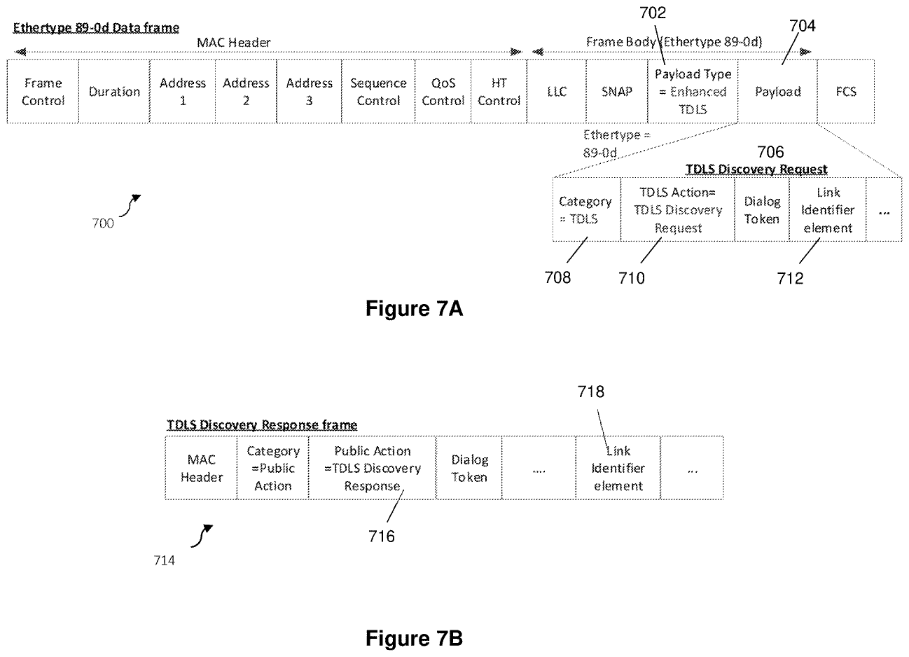

FIG. 7A depicts an illustration of a TDLS Discovery Request frame format 700 in which a TDLS Discovery Request frame 706 is encapsulated in an Ethertype 89-0d Data frame according to an embodiment of the present disclosure. A Payload Type field 702 is set to Enhanced TDLS which indicates that the Data frame is for Enhanced TDLS. Alternatively, the Payload Type field may be set to TDLS which is the same as the conventional TDLS. In that case, some signaling is included in a Payload field 704 for indicating eTDLS capability or preference as explained later. These options for Payload Type field may also be applied to other TDLS frames. A Payload field 704 comprises the TDLS Discovery Request frame 706 which includes a Category field 708 set to TDLS, a TDLS Action field 710 indicating that the frame 706 is for a TDLS Discovery Request, and a Link Identifier element 712. The TDLS Discovery Request frame format 700 may be used as the encapsulated TDLS Discovery Request frame 610 of FIG. 6. If Aggregated media access control (MAC) service data unit (A-MSDU) is used for encapsulating the TDLS Discovery Request frame 706, the source and destination addresses are carried in the subframe header and not in the address field. In that case, the Destination Address (DA) and Source Address (SA) is included in the subframe header.

FIG. 7B depicts an illustration of a TDLS Discovery Response frame format 714 according to an embodiment of the present disclosure. A Public Action frame is used for the TDLS Discovery Response frame format 714. A Public Action field 716 indicates that the frame is for Enhanced TDLS Discovery response. The TDLS Discovery Response frame 714 also comprises a Link Identifier element 718.

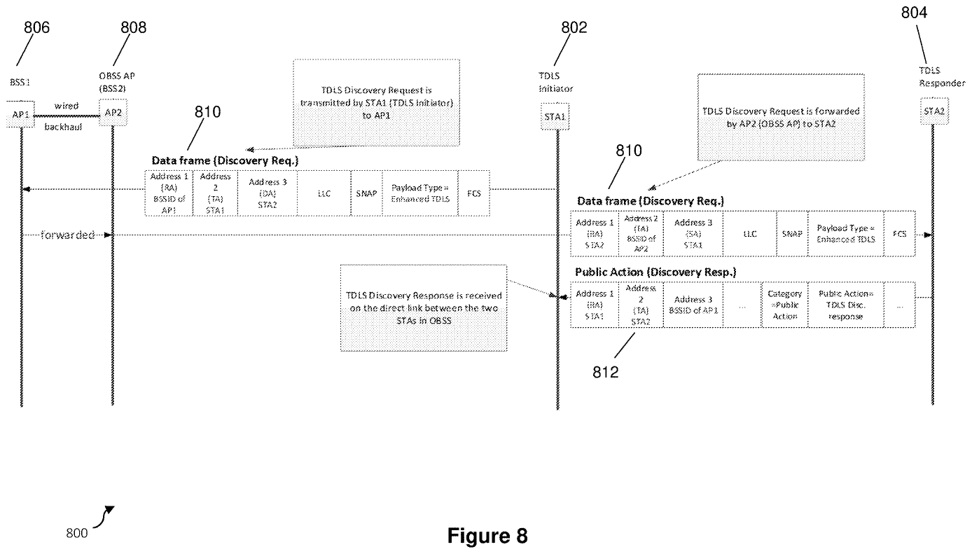

FIG. 8 depicts an illustration of a TDLS Discovery frame exchange signalling flow diagram 800 for an AP-to-AP wired backhaul according to an embodiment of the present disclosure. The process begins with a TDLS Initiator STA 802 transmitting a TDLS Discovery request 810 to its associated AP 806 under a BSS1. The TDLS Discovery request 810 may be in the same format as the TDLS Discovery Request frame format 700, in which an Address 1 field indicates a BSSID of AP 806 as a Receiving Address (RA), an Address 2 field indicates an address of STA 802 as a Transmitting Address (TA), an Address 3 field indicates an address of a STA 804 (e.g., the TDLS Responder) as a Destination Address (DA), and a Payload Type field indicating Enhanced TDLS. The TDLS Discovery Request 810 is then relayed from the AP 806 to an AP 808 which is under a BSS2 (e.g., an OBSS) via a wired backhaul (e.g., AP 806 and AP 808 are connected via a wired backhaul), which is then forwarded from the AP 808 to the STA 804. When Ethernet (or other wired backhaul) is used between the APs 806 and 808, RA and TA are not required because AP 806 and AP 808 are included in the same L2 broadcast segment. The TDLS Discovery Request 810 received by the STA 804 from the AP 808 is now different in that the Address 1 field indicates the address of the STA 804 as the RA, the Address 2 field indicates the BSSID of AP 808 as the TA, and the Address 3 field indicates the address of STA 802 as the SA. The Payload Type field remains unchanged. In response, the STA 804 transmits a TDLS Discovery Response 812 on a direct link to the STA 802. The TDLS Discovery Response 812 may be in the same format as the TDLS Discovery Response frame format 714, in which an Address 1 field indicates the address of the STA 802 as the RA, an Address 2 field indicates the address of STA 804 as the TA, an Address 3 field indicates the BSSID of AP 806, and a Payload Type field indicating Enhanced TDLS. Other options for the Address 3 field of the TDLS Discovery Response 812 may be a BSSID which the TDLS responder (e.g., STA 808) belongs to, or it may be unique ID that is assigned by the TDLS Initiator (e.g., STA 802) for the TDLS Discovery Request. Before attempting TDLS Discovery, STA 802 may have found that STA 804 is a peer STA of an intended service by some method, a typical example being by higher layer or application-level service discovery such as UPnP or Bonjour. After recognizing the IP address of the Peer STA by the service discovery, STA 802 can determine the STA 804 MAC address by Address Resolution Protocol (ARP). However, STA 802 may not know any information about (even the existence of) AP2 and BSS2 in this process.

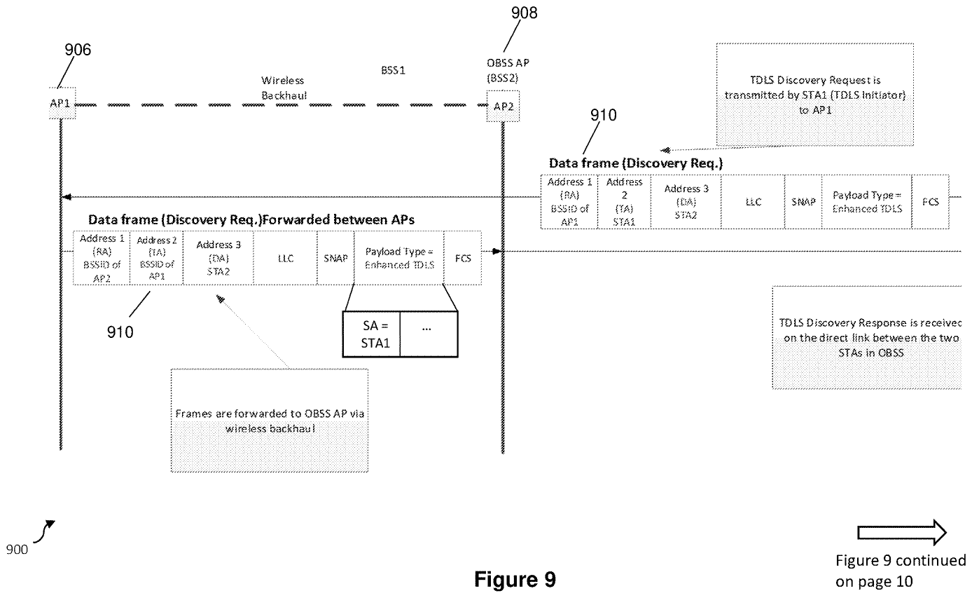

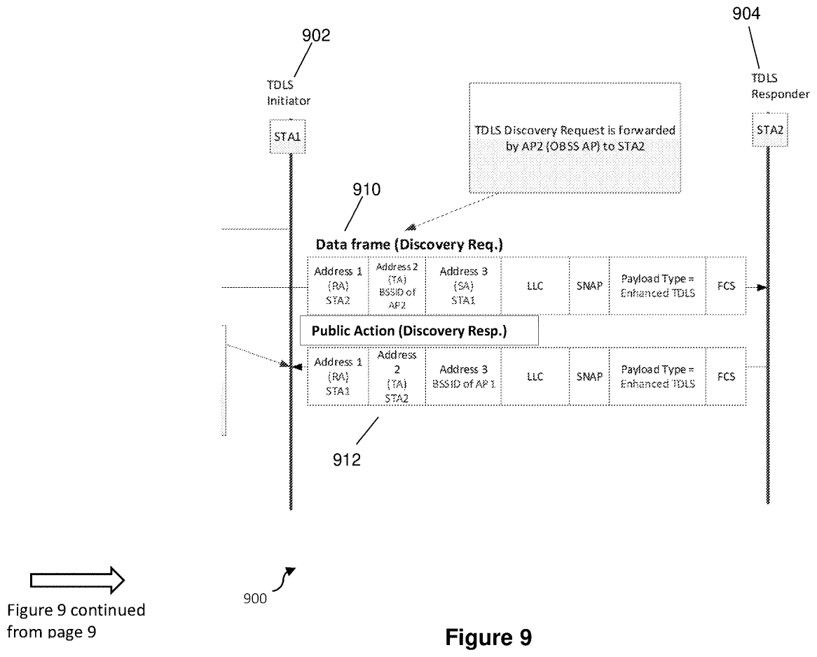

FIG. 9 depicts an illustration of a TDLS Discovery frame exchange signalling flow diagram 900 for an AP-to-AP wireless backhaul according to an embodiment of the present disclosure. The process begins with a TDLS Initiator STA 902 transmitting a TDLS Discovery request 910 to its associated AP 906 under a BSS1. The TDLS Discovery request 910 may be in the same format as the TDLS Discovery Request frame format 700, in which an Address 1 field indicates a BSSID of AP 906 as a RA, an Address 2 field indicates an address of STA 902 as a TA, an Address 3 field indicates an address of a STA 904 (e.g., the TDLS Responder) as a DA, and a Payload Type field indicating Enhanced TDLS. The TDLS Discovery Request 910 is then forwarded from the AP 906 to an AP 908 which is under a BSS2 (e.g., an OBSS) via a wireless backhaul (e.g., AP 906 and AP 908 are connected via a wireless backhaul). The TDLS Discovery request 910 received by the AP 908 from the AP 906 is now configured differently, in that the Address 1 field indicates a BSSID of AP 908 as the RA and the Address 2 field indicates the BSSID of AP 906 as the TA. The Address 3 field and Payload Type field remains unchanged.

The TDLS Discovery request 910 received by the AP 908 is then forwarded from the AP 908 to the STA 904. The TDLS Discovery Request 910 received by the STA 904 from the AP 908 is further configured differently in that the Address 1 field indicates the address of the STA 904 as the RA, the Address 2 field indicates the BSSID of AP 908 as the TA, and the Address 3 field indicates the address of STA 902 as the SA. In response, the STA 904 transmits a TDLS Discovery Response 912 on a direct link to the STA 902. The TDLS Discovery Response 912 may be in the same format as the TDLS Discovery Response frame format 714, in which an Address 1 field indicates the address of the STA 902 as the RA, an Address 2 field indicates the address of STA 904 as the TA, an Address 3 field indicates the BSSID of AP 906, and a Payload Type field indicating Enhanced TDLS.

When wireless backhaul is used (e.g., connecting AP 906 and AP 908), the AP 906 may use the three-address format with the Address 1 field set to the MAC address of the AP 908 as RA, the Address 2 field set to the own MAC address of the AP 906 as TA and the Address 3 field set to the MAC address of the STA 904 as DA. The TDLS responder STA 904, however, need to know the MAC address of the TDLS initiator STA 902 as SA which is missing in the MAC header. In this case, the TDLS initiator STA 902 may include the MAC address of the STA 902 (as SA) in the Payload by adding an SA field in addition to the TDLS Discovery Request Action field or by modifying the TDLS Discovery Request Action field format for eTDLS to include the SA field in it. Alternatively, the AP 906 may spoof the TA to MAC address of STA 902 using the three-address format (RA/TA/DA). The AP 908 treats it as the frame from the DS, e.g., AP 908 forwards the frame with the SA set to the MAC address of STA 902 (TA of the received frame). Special security treatment may be implemented for the link, for example utilizing security methods that may be proprietary. In another implementation, the contents of the TDLS Discovery request 910 may be encapsulated in a forwarding frame indicating the SA (e.g., the MAC address of STA 902), the forwarding frame being configured to be transmitted to AP 908. AP 908 interprets the forwarding frame and forwards the contents by a Data frame to the STA 904. The SA of the Data frame that is forwarded to STA 904 is set to the MAC address of STA 902 using the embedded information in the forwarding frame. From a 802.11 perspective, these AP-AP link implementations is out of scope and implementation-specific. In yet another implementation, the four-address format may be used to include RA/TA/DA/SA as follows. These options for AP-AP link may also be applied to other TDLS frames forwarded by APs.

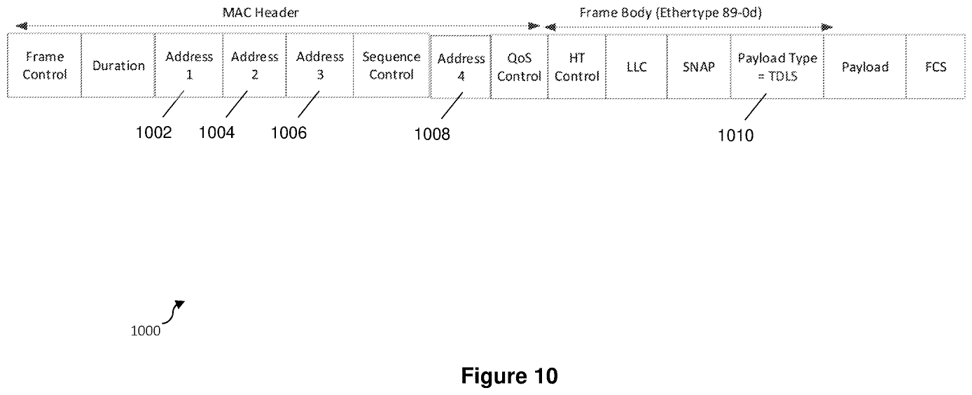

FIG. 10 depicts an illustration of a 4-address Data frame format 1000 for AP-to-AP communication according to an embodiment of the present disclosure. Based on diagram 900 as an example, the addressing in the frame format 1000 are as follows for communication between AP to AP (e.g., between AP 906 and AP 908). From DS field and To DS field (not shown) are both set to 1. Address 1 field 1002 is set to the BSSID of BSS2 (e.g., BSS associated with AP 908) as the RA. Address 2 field 1004 is set to the BSSID of BSS1 (e.g., BSS associated with AP 906) as the TA. Address 3 field 1006 is set to the address of STA 904 as the DA. Address 4 field 1008 is set to the address of STA 902 as the SA. Further, Payload Type field 1010 is set to TDLS.

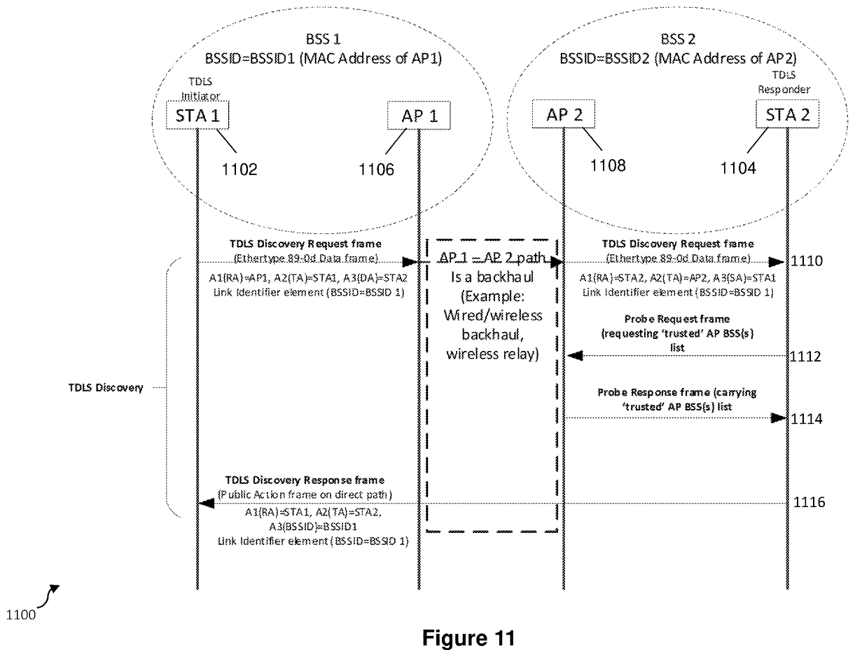

FIG. 11 depicts an illustration 1100 of an enhanced TDLS Discovery procedure in which a Link Identifier element in the TDLS Discovery frames indicate a BSS Identifier (BSSID) of a BSS associated with a TDLS initiator according to an embodiment of the present disclosure. STA 1102 initiates TDLS procedure (e.g., the TDLS Initiator) in a similar way to conventional TDLS procedure, except that an enhanced TDLS flag (indicating the STA 1102's capability or preference of enhanced TDLS) is included in a TDLS Discovery Request frame 1110. The flag may be carried in a capabilities element (such as an Extended Capabilities element) or a newly defined Extended TDLS element). In the TDLS Discovery Request frame 1110 transmitted from STA 1102 to associated AP 1106, the Address 1 field is set to the address of AP 1106 as the RA, the Address 2 field is set to the address of STA 1102 as the TA, the Address 3 field is set to the address of STA 1104 (e.g., the TDLS Responder) as the DA, and the Link Identifier element indicates a BSSID1 (e.g., an identifier of the BSS associated with AP 1106, or the MAC address of AP 1106). The TDLS Discovery Request frame 1110 is then forwarded by the AP 1106 to AP 1108 (e.g., an AP associated with the TDLS Responder STA 1104). The AP-to-AP path between AP 1106 and AP 1108 may be a wired or wireless backhaul, or a wireless relay, or other similar paths.

After receiving the TDLS Discovery Request frame 1110, the AP 1108 then transmits the frame to the STA 1104. The TDLS Discovery Request frame 1110 received by the STA 1104 is now configured differently such that the Address 1 field is set to the address of STA 1104 as the RA (e.g., the frame 1110 is to be received by the STA 1104), the Address 2 field is set to the address of AP 1108 as the TA (e.g., the frame 1110 is transmitted from the AP 1108), the Address 3 field is set to the address of STA 1102 as the SA (e.g., the frame 1110 originates from the TDLS Initiator STA 1102), and the Link Identifier element indicates the BSSID1. However, STA 1104 does not know whether BSS1 is a trusted network or not (e.g., whether the AP to AP path is secure or not) at this point. Thus, the STA 1104 may check whether the BSS with BSSID1 is trustable by sending a Probe Request frame 1112 requesting a list of trusted AP BSS(s) from the AP 1108, and the requested list may be provided in a Probe Response frame 1114 to the STA 1104 from the AP 1108. An example of a trusted AP (or BSS) is the AP 1106 (or BSS1) in an ESS to which the TDLS initiator STA 1102 belongs. If the STA 1104 finds BSSID1 in the trusted AP list, the STA 1104 may send a TDLS Discovery Response frame 1116 on a direct link to the STA 1102. The TDLS Response frame 1116 may be configured such that the Address 1 field is set to the address of STA 1102 as the RA (e.g., the frame 1116 is to be received by the STA 1102), the Address 2 field is set to the address of STA 1104 as the TA (e.g., the frame 1116 is transmitted from the STA 1104), the Address 3 field indicates BSSID1, and the Link Identifier element also indicates the BSSID1. After receiving the Response frame 1116, STA 1102 may accept to setup TDLS direct link.

In an implementation, STA 1104 may already have knowledge about trusted APs, e.g., by listening a Beacon frame or a Probe Response frame from AP 1108 including a trusted AP information. In this case, the Probe Request/Response frame exchange can be omitted after receiving TDLS Discovery Request frame 1110. In another implementation, STA 1104 may also know the trusted AP(s) from an association process by receiving the trusted AP information carried by an Association Response frame. In another implementation, trusted AP information may be included in some element(s) such as a Reduced Neighbor Report (RNR) or Neighbor Report element. In a multi-AP operation, a specific element (e.g., Multi-AP element) may include the trusted AP information. It may be included in, for example, a RNR element carried by the Multi-AP element or directly included in the fields outside the RNR element in the Multi-AP element.

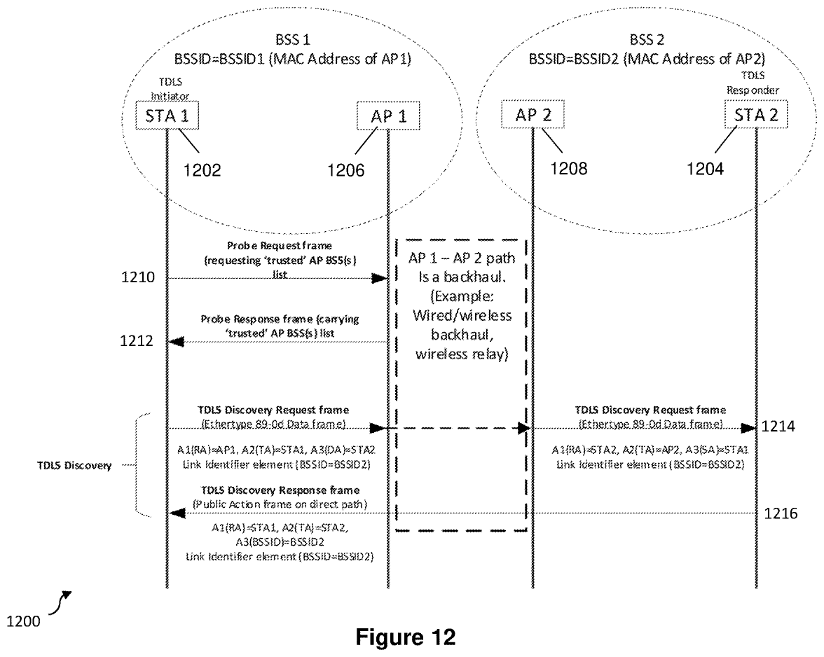

FIG. 12 depicts an illustration 1200 of an enhanced TDLS Discovery procedure in which a Link Identifier element in the TDLS Discovery frames indicate a BSSID of a BSS associated with a TDLS peer STA according to an embodiment of the present disclosure. In this example, it is assumed that TDLS Initiator STA 1202 has already discovered STA 1204 as a potential TDLS peer STA, and also knows, by some way, which AP and BSS the STA 1208 is associated with (e.g., AP 1208 and BSS2 in this case). For example, this can be done by utilizing a Fast Initial Link Setup (FILS) discovery frame for peer STA discovery. However, STA 1202 does not know whether BSS2 is a trusted network or not (e.g., whether the AP to AP path is secure or not) at this point. Thus, the STA 1202 may check whether the BSS with BSSID2 is trustable by sending a Probe Request frame 1210 requesting a list of trusted AP BSS(s) from associated AP 1206, and the requested list may be provided in a Probe Response frame 1212 to the STA 1202 from the AP 1206. If STA 1202 knows that the potential TDLS peer STA (STA 1204) is associated with a trusted AP/BSS (AP 1208/BSS2; e.g., in the same ESS), STA 1202 may perform TDLS Discovery/Setup procedure in which the BSSID field in an Address field or in Link Identifier element is set to BSSID2. For example, the STA 1202 may send a TDLS Discovery Request frame 1214 to the AP 1206 to initiate TDLS with STA 1204. The TDLS Discovery Request frame 1214 may be configured such that the Address 1 field is set to the address of AP 1206 as the RA, the Address 2 field is set to the address of STA 1202 (e.g., the TDLS Initiator) as the TA, the Address 3 field is set to the address of STA 1204 (e.g., the TDLS Responder) as the DA, and the Link Identifier element indicates a BSSID2 (e.g., an identifier of the BSS2 associated with AP 1206, or the MAC address of AP 1206). The TDLS Discovery Request frame 1214 is then forwarded by the AP 1206 to AP 1208 (e.g., an AP associated with the TDLS Responder STA 1204). The AP-to-AP path between AP 1206 and AP 1208 may be a wired or wireless backhaul, or a wireless relay, or other similar paths.

After receiving the TDLS Discovery Request frame 1214, the AP 1208 then transmits the frame to the STA 1204. The TDLS Discovery Request frame 1214 received by the STA 1204 is now configured differently such that the Address 1 field is set to the address of STA 1204 as the RA (e.g., the frame 1214 is to be received by the STA 1204), the Address 2 field is set to the address of AP 1208 as the TA (e.g., the frame 1214 is transmitted from the AP 1208), the Address 3 field is set to the address of STA 1202 as the SA (e.g., the frame 1214 originates from the TDLS Initiator STA 1202), and the Link Identifier element indicates the BSSID2. Since the Link Identifier element includes BSSID2 e.g., the BSS associated with the STA 1204, STA 1204 may behave in a similar way to conventional TDLS procedure. The STA 1204 may send a TDLS Discovery Response frame 1216 on a direct link to the STA 1202. The TDLS Discovery Response frame 1216 may be configured such that the Address 1 field is set to the address of STA 1202 as the RA (e.g., the frame 1216 is to be received by the STA 1202), the Address 2 field is set to the address of STA 1204 as the TA (e.g., the frame 1216 is transmitted from the STA 1204), the Address 3 field indicates BSSID2, and the Link Identifier element also indicates the BSSID2. After receiving the Response frame 1216, STA 1202 may accept to setup TDLS direct link.

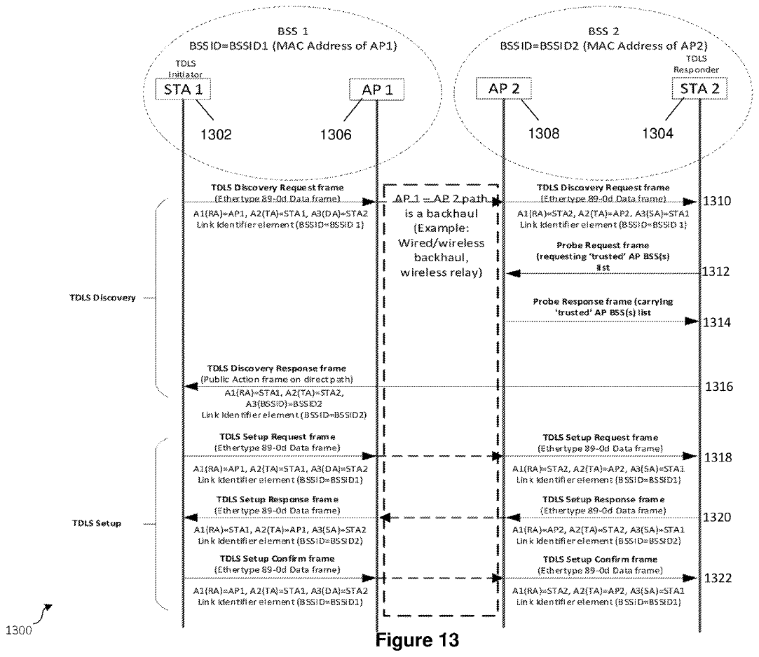

FIG. 13 depicts an illustration 1300 of an enhanced TDLS Discovery procedure in which a Link Identifier element in the TDLS Discovery frames indicate BSSIDs of a BSS associated with a TDLS initiator and a BSS associated with a TDLS peer STA according to an embodiment of the present disclosure. STA 1302 initiates TDLS procedure (e.g., the TDLS Initiator) in a similar way to conventional TDLS procedure, except that an enhanced TDLS flag (indicating the STA 1302's capability or preference of enhanced TDLS) is included in a TDLS Discovery Request frame 1310. The flag may be carried in a capabilities element (such as an Extended Capabilities element) or a newly defined Extended TDLS element). In the TDLS Discovery Request frame 1310 transmitted from STA 1302 to associated AP 1306, the Address 1 field is set to the address of AP 1306 as the RA, the Address 2 field is set to the address of STA 1302 as the TA, the Address 3 field is set to the address of STA 1304 (e.g., the TDLS Responder) as the DA, and the Link Identifier element indicates a BSSID1 (e.g., an identifier of the BSS1 associated with AP 1306, or the MAC address of AP 1306). The TDLS Discovery Request frame 1310 is then forwarded by the AP 1306 to AP 1308 (e.g., an AP associated with the TDLS Responder STA 1304). The AP-to-AP path between AP 1306 and AP 1308 may be a wired or wireless backhaul, or a wireless relay, or other similar paths.

After receiving the TDLS Discovery Request frame 1310, the AP 1308 then transmits the frame to the STA 1304. The TDLS Discovery Request frame 1310 received by the STA 1304 is now configured differently such that the Address 1 field is set to the address of STA 1304 as the RA (e.g., the frame 1310 is to be received by the STA 1304), the Address 2 field is set to the address of AP 1308 as the TA (e.g., the frame 1310 is transmitted from the AP 1308), the Address 3 field is set to the address of STA 1302 as the SA (e.g., the frame 1310 originates from the TDLS Initiator STA 1302), and the Link Identifier element indicates the BSSID1. However, STA 1304 does not know whether BSS1 is a trusted network or not (e.g., whether the AP to AP path is secure or not) at this point. Thus, the STA 1304 may check whether the BSS with BSSID1 is trustable by sending a Probe Request frame 1312 requesting a list of trusted AP BSS(s) from the AP 1308, and the requested list may be provided in a Probe Response frame 1314 to the STA 1304 from the AP 1308. An example of a trusted AP (or BSS) is the AP 1306 (or BSS1) in an ESS to which the TDLS initiator STA 1302 belongs. If the STA 1304 finds BSSID1 in the trusted AP list, the STA 1304 may send a TDLS Discovery Response frame 1316 on a direct link to the STA 1302. The TDLS Response frame 1316 may be configured such that the Address 1 field is set to the address of STA 1302 as the RA (e.g., the frame 1316 is to be received by the STA 1302), the Address 2 field is set to the address of STA 1304 as the TA (e.g., the frame 1316 is transmitted from the STA 1304), the Address 3 field indicates BSSID2 (e.g., an identifier of a BSS2 associated with AP 1306, or the MAC address of AP 1306), and the Link Identifier element also indicates the BSSID2. After receiving the Response frame 1316, STA 1302 may accept to setup TDLS direct link. In an implementation, if STA 1302 receives a valid TDLS Discovery Response frame except that the BSSID field in the Link Identifier element is invalid (e.g., other address fields, Dialog Token field etc. are valid), STA 1302 may still recognize that BSSID2 (e.g., indicated in the Address 3 field of the TDLS Discovery Response frame 1316) is trustable. STA 1302 may then include BSSID1 in the BSSID fields in transmitting frames and accept BSSID2 in BSSID fields in receiving frames from STA 1304 during TDLS setup.

During TDLS Setup, STA 1302 may transmit TDLS Setup Request frame 1318 and TDLS Setup Confirm frame 1322 via the AP 1306 and AP 1308 to the STA 1304. In an implementation, the address fields and Link Identifier element in TDLS Setup Request frames 1318 and TDLS Setup Confirm frame 1322 when transmitted from STA 1302 to AP 1306 and from AP 1308 to STA 1304 may be configured to be the same as the address fields and Link Identifier element in TDLS Discovery Request frame 1310 when transmitted from STA 1302 to AP 1306 and from AP 1308 to STA 1304 respectively. Further, STA 1304 may transmit TDLS Setup Response frame 1320 via the AP 1308 and AP 1306 to the STA 1302. The TDLS Setup Response frame 1320 transmitted from the STA 1304 to the AP 1308 may be configured such that the Address 1 field is set to the address of AP 1308 as the RA (e.g., the frame 1320 is to be received by the AP 1308), the Address 2 field is set to the address of STA 1304 as the TA (e.g., the frame 1320 is transmitted from the STA 1304), the Address 3 field is set to the address of STA 1302 as the DA, and the Link Identifier element indicates the BSSID2. The TDLS Setup Response frame 1320 transmitted from the AP 1306 to the STA 1302 may be configured such that the Address 1 field is set to the address of STA 1302 as the RA (e.g., the frame 1320 is to be received by the STA 1302), the Address 2 field is set to the address of AP 1306 as the TA (e.g., the frame 1320 is transmitted from the AP 1306), the Address 3 field is set to the address of STA 1304 as the SA, and the Link Identifier element indicates the BSSID2.

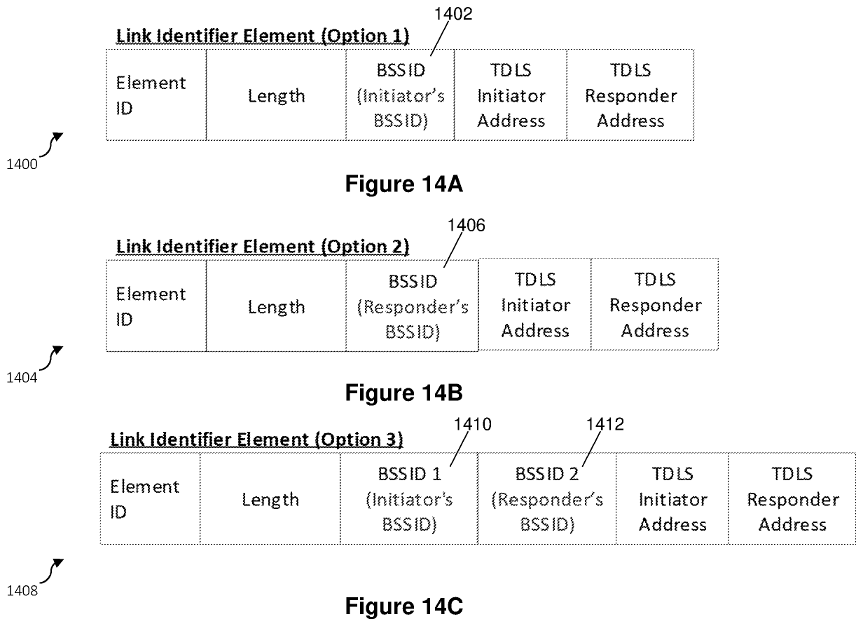

FIG. 14A depicts a Link Identifier element 1400 for use in the illustration of FIG. 11 according to an embodiment of the present disclosure. For example, a BSSID field 1402 in the Link Identifier element 1400 (e.g., included in the TDLS Discovery Request/Response frames 1110 and 1116) may indicate an initiator's BSSID (e.g., BSSID1 of illustration 1100). FIG. 14B depicts a Link Identifier element 1404 for use in the illustration of FIG. 12 according to an embodiment of the present disclosure. For example, a BSSID field 1406 in the Link Identifier element 1404 (e.g., included in the TDLS Discovery Request/Response frames 1214 and 1216) may indicate a Responder's BSSID (e.g., BSSID2 of illustration 1200). Further, FIG. 14C depicts a Link Identifier element 1408 for use in the illustration of FIG. 13 according to an embodiment of the present disclosure. For example, a BSSID 1 field 1410 and BSSID 2 field 1412 in the Link Identifier element 1408 (e.g., included in the TDLS Discovery Request/Response frames 1314 and 1316, as well as the TDLS Setup Request/Response frames 1318, 1322 and 1320) may indicate the initiator's BSSID (e.g., BSSID1 of illustration 1300) and the Responder's BSSID (e.g., BSSID2 of illustration 1300) respectively.

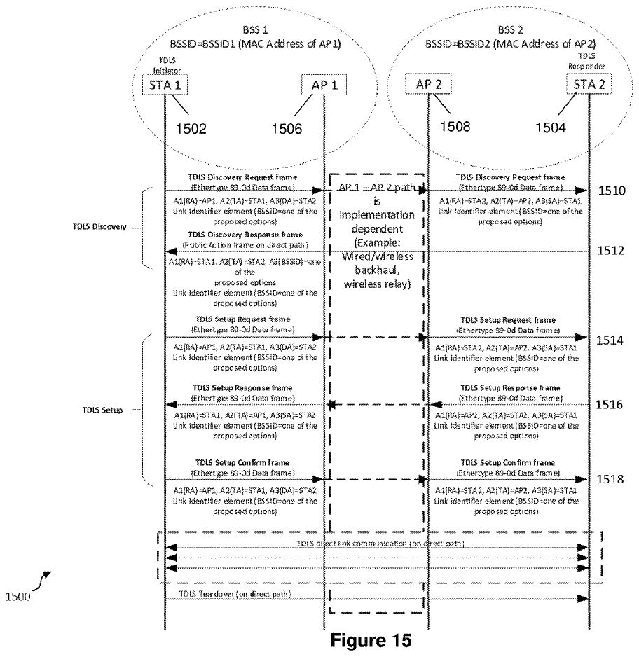

FIG. 15 depicts an illustration 1500 of overall signalling details of an enhanced TDLS Discovery procedure according to an embodiment of the present disclosure. In this example, the address fields of a TDLS Discovery Request frame 1510, a TDLS Setup Request frame 1514 and a TDLS Setup Confirm frame 1518 when transmitted from a STA 1502 (e.g., the TDLS Initiator) to AP 1506 (e.g., AP associated with STA 1502) and from AP 1508 (e.g., OBSS AP associated with a peer STA 1504) to STA 1504 (e.g., the TDLS Responder) may be configured to be the same as the address fields in TDLS Discovery Request frames 1110, 1214 and 1310 as well as TDLS Setup Request frames 1318 and 1322 when transmitted from their respective TDLS Initiator STA (via the respective APs) to their respective TDLS Responder. However, the Link Identifier element in the TDLS Discovery Request frame 1510, the TDLS Setup Request frame 1514 and the TDLS Setup Confirm frame 1518 may be configured to indicate either BSSID1 (e.g., BSSID of a BSS1 associated with the AP 1506), BSSID2 (e.g., BSSID of a BSS2 associated with the AP 1508), or both BSSID1 and BSSID2 depending on the desired implementation.

Similarly, the address fields of a TDLS Discovery Response frame 1512 (e.g., when transmitted from the STA 1504 to AP 1508 and from AP 1506 to STA 1502) may be configured to be largely the same as the address fields in TDLS Discovery Response frames 1116, 1216 and 1316 when transmitted from their respective TDLS Responder STA (via the respective APs) to their respective TDLS Initiator STA. However, the Address 3 field and Link Identifier element in the TDLS Discovery Response frame 1512 may each be configured to indicate either BSSID1, BSSID2, or both BSSID1 and BSSID2 depending on the desired implementation.

Further, the address fields of a TDLS Setup Response frame 1516 (e.g., when transmitted from the STA 1504 to AP 1508 and from AP 1506 to STA 1502) may be configured to be the same as the address fields in TDLS Setup Response frame 1320 when transmitted from its respective TDLS Responder STA (via the respective APs) to its respective TDLS Initiator STA. However, the Link Identifier element in the TDLS Setup Response frame 1516 may be configured to indicate either BSSID1, BSSID2, or both BSSID1 and BSSID2 depending on the desired implementation. After the TDLS Setup Confirm frame 1518 is received by STA 1504, TDLS direct link communication on a direct path can proceed between STA 1502 and STA 1504 until TDLS teardown is executed.

It is possible that the peer STA in the OBSS is operating on a channel different from the channel of the TDLS Initiator, in which case the peer STA (TDLS Responder) switches the channel to the primary channel of the TDLS Initiator's BSS and responds in the switched channel. The signalling for request of channel switch can be done either during the TDLS Discovery or during the TDLS Setup phase. For example, the TDLS initiator includes its operating channel in a TDLS Discovery Request or a TDLS Setup Request. The TDLS responder may perform a channel switch procedure and respond to the TDLS initiator by transmitting a TDLS Discovery Response or a TDLS Setup Response on the operating channel of the TDLS initiator. If the TDLS responder is going to switch its operating channel, the TDLS responder should be in power save (PS) mode with the associated AP so that the AP recognizes the TLDS responder STA will not receive traffics from the AP for a while. Optionally, off-channel TDLS may be negotiated, if needed, by defining an enhanced TDLS channel switching procedure which is similar to conventional TDLS channel switching procedure but performed via APs rather than over the direct link.

Security negotiation may be performed for a TDLS link. As explained from the next paragraph, a 3-way TPK handshake protocol performed over the setup link may be used to derive a security key such as a TDLS PeerKey (TPK) which is used for providing confidentiality and authentication of the frame exchanged over all the direct links. To enable secure TDLS link with an OBSS peer STA, it is assumed that the OBSS peer STA is present in the same ESS as the TDLS initiator. A key benefit is that this will help secure the whole path between the TDLS initiator and the TDLS responder including the AP-to-AP path. Alternatively, if the AP-AP link may not be secure, a 4-way handshake may be used instead of the 3-way handshake, for example, by adding a transmission of an Authentication frame encapsulated in a Data frame after the TDLS Setup Confirm frame or before the TDLS Setup Request frame.

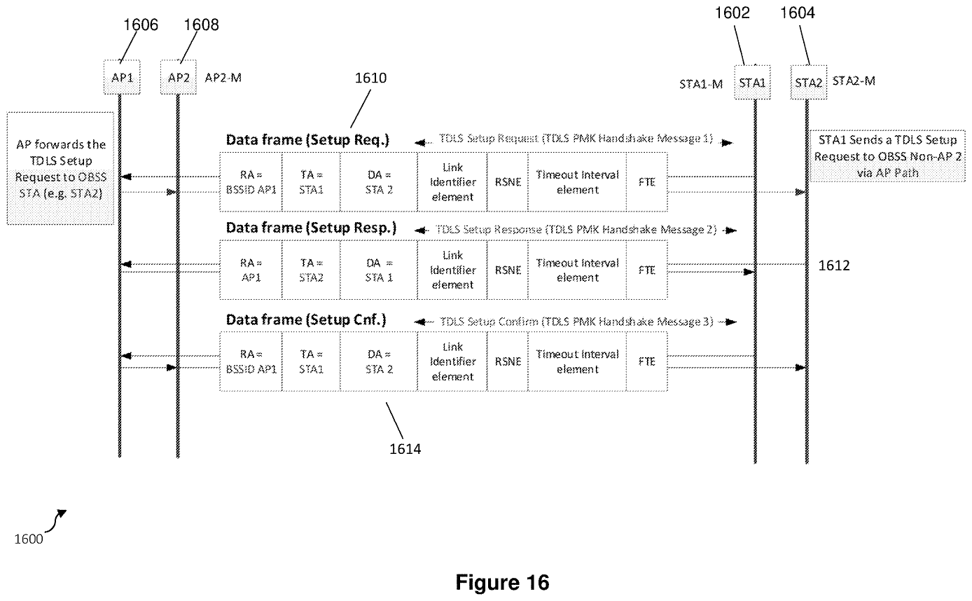

FIG. 16 depicts a security negotiation procedure for a TDLS link according to an embodiment of the present disclosure. For example, TDLS Initiator STA 1602 sends a TDLS Setup Request 1610 via associated AP 1606 and OBSS AP 1608 to OBSS peer STA 1604 (e.g., TDLS Responder). In the TDLS Setup Request 1610, BSSID of AP1 is indicated as the RA (e.g., in an Address 1 field), the address of STA 1602 is indicated as the TA (e.g., in an Address 2 field), and the address of STA 1604 is indicated as the DA (e.g., in an Address 3 field). The TDLS Setup Request 1610 may comprise a Fast BSS Transition (FTE) element that is used to derive a TPK for security negotiation, in which the TDLS Setup Request 1610 may be referred to as a TDLS Pairwise Master Key (PMK) handshake message 1. In response to the Request 1610, the STA 1604 may transmit a TDLS Setup Response 1612 (e.g., TDLS PMK handshake message 2) via AP 1608 and AP 1606 to STA 1602. In the TDLS Setup Response 1612, the address of AP1 is indicated as the RA (e.g., in an Address 1 field), the address of STA 1604 is indicated as the TA (e.g., in an Address 2 field), and the address of STA 1602 is indicated as the DA (e.g., in an Address 3 field). The TDLS Setup Response 1612 may also comprise a FTE element. In response to the Response 1612, the STA 1602 may transmit a TDLS Setup Confirmation 1614 (e.g., TDLS PMK handshake message 3) via AP 1606 and AP 1608 to STA 1604. In the TDLS Setup Confirmation 1614, the BSSID of AP 1606 is indicated as the RA (e.g., in an Address 1 field), the address of STA 1602 is indicated as the TA (e.g., in an Address 2 field), and the address of STA 1604 is indicated as the DA (e.g., in an Address 3 field). The TDLS Setup Confirmation 1614 may also comprise a FTE element. It will be appreciated that a Link Identifier element is also included in each of the frames 1610, 1612 and 1614, and the BSSID indicated in each of the Link Identifier elements depends on the desired implementation similar to illustration 1500.

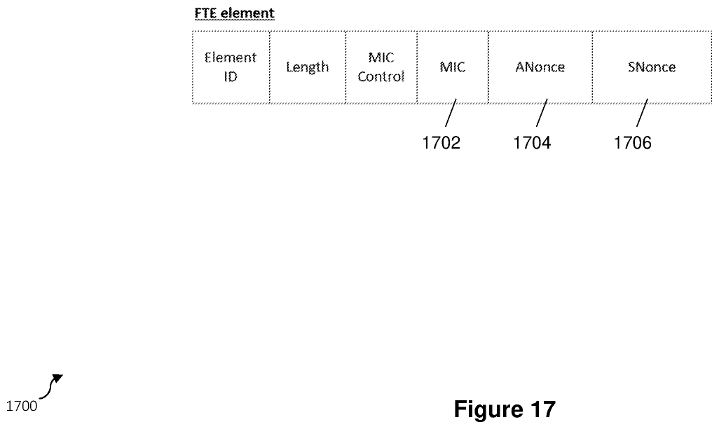

FIG. 17 depicts an illustration of a FTE element for deriving a TDK in a TDLS link security negotiation procedure according to an embodiment of the present disclosure. The FTE element 1700 may comprise a Message Integrity Code (MIC) field, an Anonce field 1704 and a Snonce field 1706. For example, the contents of the Anonce field 1704 and Snonce field 1706 are used to generate the TPK-KEY-Input as follows:

TPK-Key-Input = Hash(min (SNonce, ANonce) || max
(SNonce, ANonce))
TPK = KDF-Hash-Length(TPK-Key-Input, “TDLS PMK”,
min (MAC_I, MAC_R)|| max (MAC_I, MAC_R) || BSSID)
TPK-KCK = L(TPK, 0, 128)
TPK-TK = L(TPK, 128, Length − 128)

The Key Confirmation Key (KCK) is used to provide data origin authenticity in TDLS Setup Response and TDLS Setup Confirm frames while the same TPK-TK is used to provide confidentiality for all protected frames transmitted over the direct link. Here, BSSID, MAC_I and MAC_R are the values of the BSSID, TDLS Initiator STA Address and the TDLS responder STA Address fields of the Link Identifier element carried in the TDLS Setup frames respectively.

The MIC value may be calculated for the TPK handshake messages 2 & 3 (e.g., TDLS Setup Response 1612 and TDLS Setup Confirmation 1614 respectively). The values of the TDLS Initiator STA Address and the TDLS responder STA Address fields of the Link Identifier element carried in the TDLS Setup frames are used as the TDLS Initiator STA MAC address and TDLS Responder STA MAC address, respectively. The MIC shall be calculated on the concatenation, in the following order, of:
TDLS initiator STA MAC address (6 octets)
TDLS responder STA MAC address (6 octets)
Transaction Sequence number (1 octet) which shall be set to the value 2 or 3
Link Identifier element
RSNE
Timeout Interval element
FTE, with the MIC field of the FTE set to 0.
   The MIC may be calculated using the TPK-KCK and the AES-128-CMAC algorithm.

Rules for Additional Authenticated Data (AAD) and Nonce calculation during Counter Mode with Cipher Block Chaining Message Authentication Code Protocol (CCMP) or Galois/Counter Mode Protocol (GCMP) encapsulation/decapsulation for Data frames exchanged between two non-APs over the direct link may be as follows. The MAC address of the recipient is used as the Address 1 field for the AAD construction. The MAC address of the transmitting AP is used as the Address 2 field for the AAD and Nonce construction. If the non-AP STA is associated with an AP, the MAC Address of the OBSS AP is used as the Address 3 field for the AAD construction. Otherwise, the Address 3 field of the protected frame is used for the AAD construction. Alternatively, the addresses carried in the TDLS Initiator STA Address, TDLS Responder STA Address and the BSSID fields of the Link Identifier element carried in the TDLS Setup frames may be used instead in the AAD and Nonce construction.

In an embodiment, TDLS can be extended to a Virtual BSS (VBSS) architecture. A scenario of VBSS can be considered where multiple APs in an ESS belonging to a “multi-AP group” forms a Virtual BSS. Each AP may be affiliated with a corresponding multi-link device (MLD). Alternatively, a Virtual BSS may consist of MLDs instead of multiple APs. APs in a multi-AP group may follow a multi-AP coordination operation which may be specified in future IEEE 802.11 standard. Such multi-AP group may be referred to as “Coordinated AP group”. A multi-AP group may form a virtual AP device or an extended MLD in which each AP or MLD affiliated with the virtual device may not be collocated. A multi-AP group may also be a group of APs in Wi-Fi EasyMesh. A Virtual BSS has an ID similar to BSSID. It may be referred to as ‘VBSSID’ or ‘Multi-AP group ID’. In this manner, TDLS can be extended to an OBSS scenario where the peer STA is present not in the same BSS but in the VBSS e.g., the TDLS Initiator is present in one BSS and the TDLS Responder is present in another BSS but both are part of the same VBSS. In an implementation, the BSSID field of the Link Identifier element shall set the BSSID to VBSSID if both the STAs support enhanced TDLS. The capabilities for enhanced TDLS shall be indicated by each capable STA during the TDLS Discovery phase.

For a VBSS scenario, STA1 transmits a TDLS Discovery Request frame encapsulated in an Ethertype 89-0d Data frame in a BSS1 with the following parameters: To DS field=1, From DS field=0, Address 1 field: RA=BSSID (e.g., AP1, or the AP associated with TDLS Initiator), Address 2 field: TA=STA1 (e.g., address of TDLS Initiator), Address 3 field: DA=STA2 (e.g., address of TDLS Responder in OBSS). AP1 (in BSS1) forwards the Data frame to AP2 (e.g., AP associated with the TDLS Responder in BSS2) via a DS. AP1 and AP2 may belong to an ESS and are connected to a single common DS. The DS may be implemented in various ways (e.g., on wired or wireless backhaul), but the information of the source address (STA1 MAC address) and the destination address (STA2 MAC address) are informed from AP1 to AP2 e.g., via Ethernet frame header on wired backhaul, or four-address format Data frame header on wireless backhaul. The four-address format is used in AP-AP communication in some devices which support on-channel relay and in some EasyMesh implementations. Furthermore, AP2 transmits the Data frame to STA2 in a BSS2 with the following parameters: To DS field=0, From DS field=1, Address 1 field: RA=BSSID (AP1), Address 2 field: TA=STA1, Address 3 field: DA=STA2 (in OBSS).

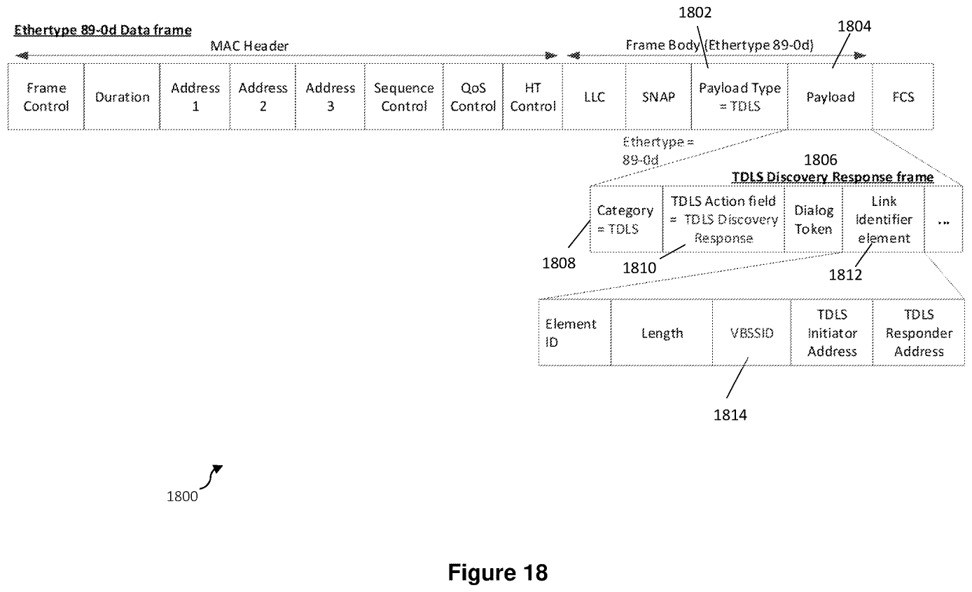

FIG. 18 depicts a variation of a TDLS Discovery Response frame format 1800 that may be used in a VBSSID setting according to an embodiment of the present disclosure. A Payload Type field 1802 indicates that the Data frame is for TDLS. A Payload field 1804 comprises the TDLS Discovery Response frame 1806 which includes a Category field 1808 set to TDLS, a TDLS Action field 1810 indicating that the frame 1806 is for a TDLS Discovery Response, and a Link Identifier element 1812. The Link Identifier element 1812 may indicate VBSSID in a BSSID field 1814.

In an embodiment, AP1 (AP associated with a TDLS Initiator STA1) and AP2 (AP associated with a TDLS Responder STA2) may be collocated (e.g., in a single wireless router), in a multiple BSSID set. For example, AP1 belongs to a main BSS (BSS1) which has a transmitted BSSID, and AP2 belongs to a guest BSS (BSS2) which has a non-transmitted BSSID, each belonging to separate VLANs. In this case, the APs do not belong to a single ESS, but the bar is lower than independent APs because the both STAs have knowledge of a common transmitted BSSID and the AP1-to-AP2 data path is considered to be secure since both APs are implemented in a single device (e.g., wireless router). In this scenario, the TDLS initiator may know that the AP1-AP2 data path and the AP2 are secure from information (signaling) of the multiple BSSID set. Signaling may be defined in a TDLS Discovery Request frame and other TDLS frames (e.g. in a reserved bit or an element) which indicates the “enhanced TDLS” capability (e.g., using a frame format similar to FIGS. 7A and 7B). For example, the BSSID field in the Link Identifier element is set to the transmitted BSSID. If the TDLS responder supports enhanced TDLS and the BSSID in the Link Identifier element is the transmitted BSSID, the responder may return a TDLS Discovery Response frame to the initiator. Similar signaling and criteria may also apply to TDLS setup or other TDLS processes. Additional security treatment may be implemented because BSSs in multiple BSSID set are intentionally separated (e.g., for guest users).

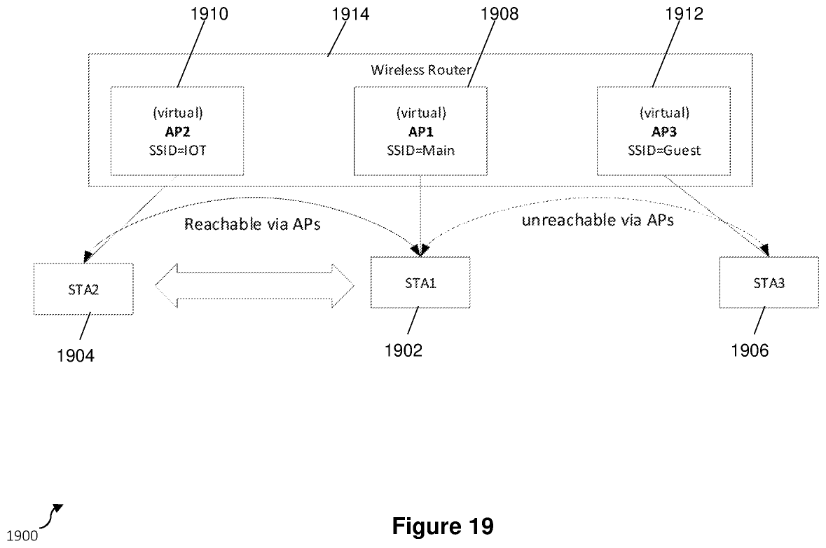

FIG. 19 depicts an illustration 1900 of a TDLS implementation with multiple BSSIDs according to an embodiment of the present disclosure. AP 1908 (e.g., AP associated with STA 1902), AP 1910 (e.g., AP associated with STA 1904) and AP 1912 (e.g., AP associated with STA 1906) are implemented in the same physical AP device in a wireless router 1914. AP 1908 is the AP of the transmitting BSSID, while AP 1910 and AP 1912 are the APs of non-transmitting BSSIDs. AP 1908 and AP 1910 belong to logically independent VLANs but traffic is allowed to be forwarded to each other. AP 1912 is isolated from other collocated APs by security policy e.g., forwarding is not allowed between AP 1912 and AP 1908, and between AP 1912 and AP 1910. For example, direct link can be established by enhanced TDLS (but not by conventional TDLS) between STA 1902 and STA 1904, but not between STA 1906 and each of the STAs 1902 and 1904. Neighbor report or RNR approach for security confirmation is also applicable to this implementation. For example, each STA can collect information of trustable APs (e.g., the path between the own BSS and the peer BSS) from their respective associated AP.

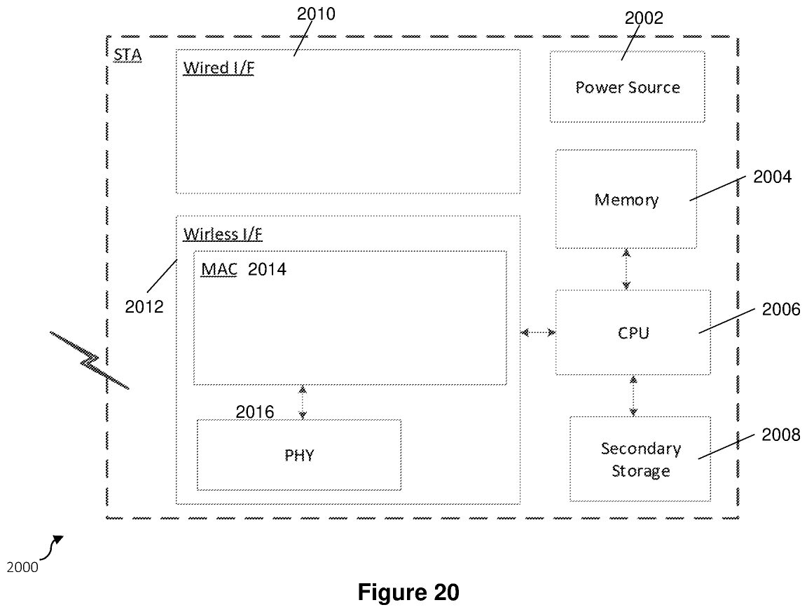

FIG. 20 depicts a block diagram of a STA 2000 suitable for communication in accordance with various embodiments of the present disclosure. The STA 2000 may be implemented as a non-AP STA or a STA suitable for enhanced TDLS according to the various embodiments of the present disclosure. The STA 2000 may comprise a power source 2002, a memory 2004, a central processing unit (CPU) 2006 and a secondary storage 2008. The STA 2000 also comprises a wired interface 2010 and a wireless interface 2012 (including a MAC layer 2014 and a physical (PHY) layer 2016) for transmitting/receiving signals to/from other communication apparatuses (e.g., other STAs/APs) for enhanced TDLS.

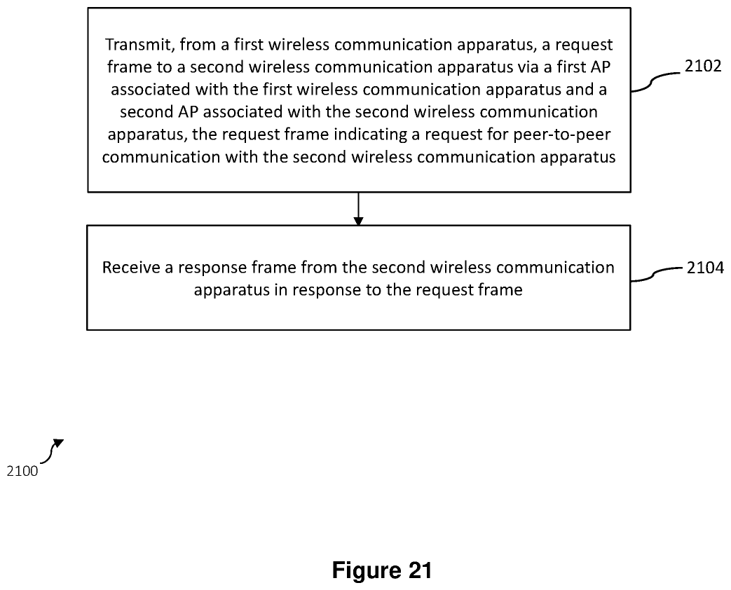

FIG. 21 shows a flow diagram 2100 illustrating a communication method according to various embodiments. At step 2102, a request frame is transmitted from a first wireless communication apparatus to a second wireless communication apparatus via a first AP associated with the first wireless communication apparatus and a second AP associated with the second wireless communication apparatus, the request frame indicating a request for peer-to-peer communication with the second wireless communication apparatus. At a step 2104, a response frame is received from the second wireless communication apparatus in response to the request frame.

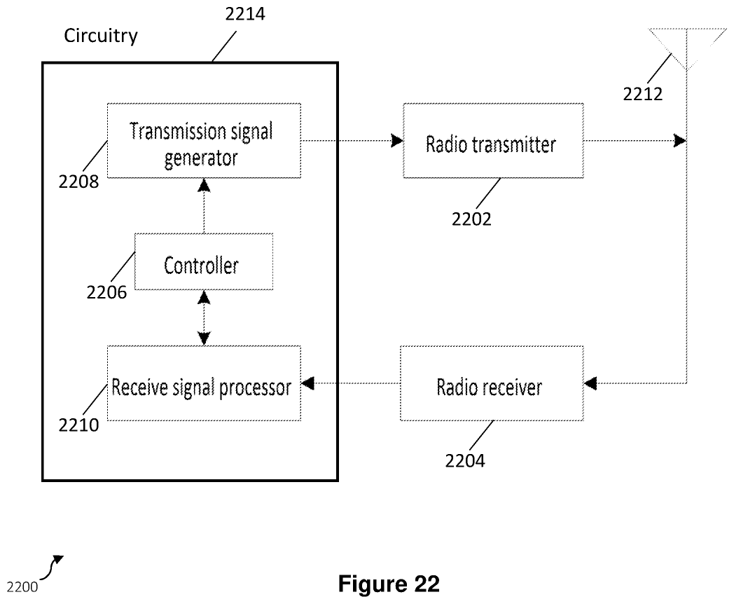

FIG. 22 shows a schematic, partially sectioned view of a communication apparatus 2200 that can be implemented for enhanced TDLS in accordance with the various embodiments. The communication apparatus 2200 may be implemented as an STA or AP according to various embodiments.

Various functions and operations of the communication apparatus 2200 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 22, the communication apparatus 2200 may include circuitry 2214, at least one radio transmitter 2202, at least one radio receiver 2204 and multiple antennas 2212 (for the sake of simplicity, only one antenna is depicted in FIG. 22 for illustration purposes). The circuitry may include at least one controller 2206 for use in software and hardware aided execution of tasks it is designed to perform, including control of communications with one or more other devices in a wireless network. The at least one controller 2206 may control at least one transmission signal generator 2208 for generating frames to be sent through the at least one radio transmitter 2202 to one or more other STAs or APs and at least one receive signal processor 2210 for processing frames received through the at least one radio receiver 2204 from the one or more other STAs or APs. The at least one transmission signal generator 2208 and the at least one receive signal processor 2210 may be stand-alone modules of the communication apparatus 2200 that communicate with the at least one controller 2206 for the above-mentioned functions. Alternatively, the at least one transmission signal generator 2208 and the at least one receive signal processor 2210 may be included in the at least one controller 2206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 2202, at least one radio receiver 2204, and at least one antenna 2212 may be controlled by the at least one controller 2206. Furthermore, while only one radio transmitter 2202 is shown, it will be appreciated that there can be more than one of such transmitters.

In various embodiments, when in operation, the at least one radio receiver 2204, together with the at least one receive signal processor 2210, forms a receiver of the communication apparatus 2200. The receiver of the communication apparatus 2200, when in operation, provides functions required for enhanced TDLS. While only one radio receiver 2204 is shown, it will be appreciated that there can be more than one of such receivers.

The communication apparatus 2200, when in operation, provides functions required for enhanced TDLS. For example, the communication apparatus 2200 may be a first wireless communication apparatus. The transmitter 2202 may, in operation, transmit a request frame to a second wireless communication apparatus which is associated to a second AP for peer-to-peer communication. The receiver 2204 may, in operation, receive a response frame from the second wireless communication apparatus in response to the request frame.

The request frame may be a Tunnelled direct-link setup (TDLS) Discovery Request frame, an Access Network Query Protocol (ANQP) request frame or a TDLS Setup Request frame. The first AP may be connected to the second AP either via wireless backhaul or wired backhaul. The first wireless communication apparatus and the first AP may belong to a first basic service set (BSS), and the second wireless communication apparatus and the second AP may belong to a second BSS that is a different BSS from the first BSS. The first and second wireless communication apparatuses may be part of a Virtual BSS (VBSS) sharing the same Virtual BSSID (VBSSID).

The circuitry 2214 may, in operation, generate the request frame with a Link Identifier element, the Link Identifier element indicating either a first BSSID associated with the first wireless communication apparatus, a second BSSID associated with the second wireless communication apparatus, or both the first and second BSSIDs. The second wireless communication apparatus may be a STA in an Extended Service Set (ESS), wherein the circuitry 2214 may be further configured to generate the request frame with a FTE element for deriving a TDLS peer key, the FTE element indicating a MIC value; and calculate the MIC value based on the Link Identifier element.

The first and second wireless communication apparatuses may be a part of a Multiple BSSID set, the first wireless communication apparatus being configured to collect, from the first AP, information relating to one or more APs along a path between a BSS associated with the first wireless communication apparatus and a peer BSS associated with the second wireless communication apparatus. The first and second APs may be a part of a plurality of collocated APs, the plurality of collocated APs being implemented in a same physical AP device.

For example, the communication apparatus 2200 may be a second wireless communication apparatus associated to a second AP. The receiver 2204 may, in operation, receive a request frame from a first wireless communication apparatus via a first AP associated with the first wireless communication apparatus and the second AP, the request frame indicating a request for peer-to-peer communication with the second wireless communication apparatus. The transmitter 2202 may, in operation, transmit a response frame to the first wireless communication apparatus in response to the request frame.

The response frame may be a TDLS Discovery Response frame, an ANQP response frame, or a TDLS Setup Response frame. The response frame may be a TDLS Discovery Response frame, and the transmitter 2202 may be configured to transmit the response frame over a direct link to the first wireless communication apparatus. The response frame may be a TDLS Setup Response frame in a payload of a data frame, and the transmitter 2202 may be configured to transmit the response frame via the second and first AP to the first wireless communication apparatus.

The second wireless communication apparatus may be an OBSS STA and be further configured to solicit information from its associated AP about a neighbouring BSS upon receiving the request frame, the request frame being a TDLS Discovery Request frame. The information being solicited from its associated AP may comprise a Reduced Neighbour Report (RNR) or Neighbour Report element reporting a list of trusted APs.

The circuitry 2214 may, in operation, generate the response frame with a Link Identifier element, the Link Identifier element indicating either a first BSSID associated with the first wireless communication apparatus, a second BSSID associated with the second wireless communication apparatus, or both the first and second BSSIDs. The second wireless communication apparatus may be a STA in an ESS, wherein the circuitry 2214 is further configured to generate the response frame with a FTE element for deriving a TDLS peer key, the FTE element indicating a MIC value, and calculate the MIC value based on the Link Identifier element.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, an ultra-LSI, or a system on a chip (SoC) depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device, head mounted display (HMD), smart glasses), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

Thus, it can be seen that the present embodiments provide communication devices and methods for enhanced TDLS.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first wireless communication apparatus associated to a first access point (AP), the first wireless communication apparatus comprising:
a transmitter, which in operation, transmits a request frame to a second wireless communication apparatus which is associated to a second AP for peer-to-peer communication; and
a receiver, which in operation, receives a response frame from the second wireless communication apparatus in response to the request frame.

2. The first wireless communication apparatus according to claim 1, wherein the request frame is a Tunnelled direct-link setup (TDLS) Discovery Request frame, an Access Network Query Protocol (ANQP) request frame or a TDLS Setup Request frame.

3. The first wireless communication apparatus according to claim 1, wherein the first AP is connected to the second AP either via wireless backhaul or wired backhaul.

4. The first wireless communication apparatus according to claim 1, wherein the first wireless communication apparatus and the first AP belong to a first basic service set (BSS), and the second wireless communication apparatus and the second AP belong to a second BSS that is a different BSS from the first BSS.

5. The first wireless communication apparatus according to claim 1, further comprising circuitry, which in operation, generates the request frame with a Link Identifier element, the Link Identifier element indicating either a first BSSID associated with the first wireless communication apparatus, a second BSSID associated with the second wireless communication apparatus, or both the first and second BSSIDs.

6. The first wireless communication apparatus according to claim 5, the second wireless communication apparatus being a STA in an Extended Service Set (ESS), wherein the circuitry is further configured to:
generate the request frame with a FTE element for deriving a TDLS peer key, the FTE element indicating a MIC value; and
calculate the MIC value based on the Link Identifier element.

7. The first wireless communication apparatus according to claim 1, wherein the first and second wireless communication apparatuses are part of a Virtual BSS (VBSS) sharing the same Virtual BSSID (VBSSID).

8. The first wireless communication apparatus according to claim 1, wherein the first and second wireless communication apparatuses are a part of a Multiple BSSID set, the first wireless communication apparatus being configured to collect, from the first AP, information relating to one or more APs along a path between a BSS associated with the first wireless communication apparatus and a peer BSS associated with the second wireless communication apparatus.

9. The first wireless communication apparatus according to claim 8, wherein the first and second APs are a part of a plurality of collocated APs, the plurality of collocated APs being implemented in a same physical AP device.

10. A second wireless communication apparatus associated to a second AP, the second wireless communication apparatus comprising:
a receiver, which in operation, receives a request frame from a first wireless communication apparatus via a first AP associated with the first wireless communication apparatus and the second AP, the request frame indicating a request for peer-to-peer communication with the second wireless communication apparatus; and
a transmitter, which in operation, transmits a response frame to the first wireless communication apparatus in response to the request frame.

11. The second wireless communication apparatus according to claim 10, wherein the response frame is a TDLS Discovery Response frame, an ANQP response frame, or a TDLS Setup Response frame.

12. The second wireless communication apparatus according to claim 10, wherein:
the response frame is a TDLS Discovery Response frame, and the transmitter is configured to transmit the response frame over a direct link to the first wireless communication apparatus; or
the response frame is a TDLS Setup Response frame in a payload of a data frame, and the transmitter is configured to transmit the response frame via the second and first AP to the first wireless communication apparatus.

13. The second wireless communication apparatus according to claim 10, the second wireless communication apparatus being an OBSS STA and further configured to solicit information from its associated AP about a neighbouring BSS upon receiving the request frame, the request frame being a TDLS Discovery Request frame.

14. The second wireless communication apparatus according to claim 13, wherein the information being solicited from its associated AP comprises a Reduced Neighbour Report (RNR) or Neighbour Report element reporting a list of trusted APs.

15. The second wireless communication apparatus according to claim 10, further comprising circuitry, which in operation, generates the response frame with a Link Identifier element, the Link Identifier element indicating either a first BSSID associated with the first wireless communication apparatus, a second BSSID associated with the second wireless communication apparatus, or both the first and second BSSIDs.

16. The second wireless communication apparatus according to claim 15, the second wireless communication apparatus being a STA in an ESS, wherein the circuitry is further configured to:
generate the response frame with a FTE element for deriving a TDLS peer key, the FTE element indicating a MIC value, and
calculate the MIC value based on the Link Identifier element.

17. A communication method comprising:
transmitting, from a first wireless communication apparatus, a request frame to a second wireless communication apparatus via a first AP associated with the first wireless communication apparatus and a second AP associated with the second wireless communication apparatus, the request frame indicating a request for peer-to-peer communication with the second wireless communication apparatus; and
receiving a response frame from the second wireless communication apparatus in response to the request frame.
